(19) United States
(12) Patent Application Publication
(10) Pub. No.: US 2004/0011579 A1
(43) Pub. Date: Jan. 22, 2004

(54) Method for actuating a component of distributed security system

(76) Inventors: Hans Heckmann, Karlsruhe (DE); Reinhard Weiberle, Vaihingen/Enz (DE); Bernd Kesch, Hemmingen (DE); Peter Blessing, Heilbronn (DE)

Correspondence Address: KENYON & KENYON, ONE BROADWAY, NEW YORK, NY, 10004, US

(21) Appl. No.: 10/276,285

(22) PCT Filed: Mar. 14, 2002
(86) PCT No.: PCT/DE02/00918

(30) Foreign Application Priority Data
Mar. 15, 2001 (DE) 10112909.2

(51) Int. Cl. B60D 1/28; B60L 3/00; B60R 21/00; B60K 28/00

(52) U.S. Cl. 180/271

(57) ABSTRACT

A method of triggering a component in a distributed safety-related system, e.g., a component of an X-by-wire system in a motor vehicle, is described. The component is triggered by a first triggering module assigned to the component and including at least one first microcomputer system. To monitor the microcomputer system, a monitoring unit which is independent of the first microcomputer system is provided. In addition to the first microcomputer system, the distributed safety-related system includes at least one additional microcomputer system which is connected to the first microcomputer system for the purpose of data transfer, e.g., via a physical databus. The additional microcomputer systems assume the functions of the monitoring unit. Thus, it is possible to do without a separate monitoring unit.

### FIELD OF THE INVENTION

The present invention relates to a method of triggering a component in a distributed safety-related system, e.g., a component of an X-by-wire system in a motor vehicle. The component is triggered by a first triggering module assigned to the component using at least one first microcomputer system. The triggering of the component includes the following steps:

a) Determining at least one triggering signal for the component by the first microcomputer system as a function of at least one input signal;

b) Determining at least one logic triggering signal, the at least one logic triggering signal is determined at least partially by a monitoring unit, which is independent of the first microcomputer system, as a function of the at least one input signal;

c) Comparing the at least one triggering signal with the at least one logic triggering signal;

d) Determining at least one enabling signal as a function of the result of the comparison; and

e) Relaying the at least one triggering signal or at least one signal which depends thereon to the component if the at least one enabling signal has a preselectable value.

The present invention also relates to a computer program capable of running on a microcomputer system of a triggering module. The triggering module is provided for triggering a component in a distributed safety-related system, e.g., a component of an X-by-wire system in a motor vehicle.

### BACKGROUND INFORMATION

German Published Patent Application No. 198 26 131 discusses a distributed safety-related system as an electric brake system of a motor vehicle. Components of this system are configured as the brakes of the motor vehicle, i.e., more precisely, as actuators for triggering the brakes. Such a system is extremely safety-related, because faulty triggering of the components, e.g., faulty actuation of the brakes, may result in an unforeseeable safety risk. For this reason, the possibility of faulty triggering of the components must be ruled out reliably.

Features of a conventional brake system include a pedal module for central determination of the driver's intent, four wheel modules for wheel-individualized regulation of the brake actuators, and a processing module for calculating higher-level brake functions. Communication among individual modules may occur through a communication system. FIG. 2 of the present patent application shows the internal structure of a wheel module including various logic levels as an example. Logic level L1 includes at least the calculation of the control and regulating functions for the wheel brakes, while logic levels L2 through L4 include different functions for computer monitoring and function testing of L1.

Triggering of the brakes, i.e., the electric motors for actuating the brake shoes, includes the following steps for each wheel module equally:

a) Determining at least one triggering signal (f_1) for the brake by a first microcomputer system (R_1A) as a function of at least one input signal (a_R2, a_R3, a_R4; a_V,ref; s_R2, s_R3, s_R4; Δs_V,ref; v_F; n_1; F_1i; s_1H). The input signals are made available to the microcomputer system (R_1A) via a communication system (K_1), e.g., a bus system.

b) Determining at least one logic triggering signal (e_1H). The logic triggering signal (e_1H) is determined at least partially by a monitoring unit (R_1B), which is independent of the first microcomputer system (R_1A), as a function of the at least one input signal.

c) Comparing the at least one triggering signal (f_1) with the at least one logic triggering signal (e_1H) in a power electronics unit (LE_1K).

d) Determining at least one enabling signal (within the power electronics LE) as a function of the result of the comparison of the triggering signal (f_1) and the logic triggering signal (e_1H); and

e) Relaying the at least one triggering signal (f_1) or a signal (i_1K) which depends on the triggering signal (f_1) to the brake, i.e., to an actuator Akt_1 for the brake shoes if the at least one enabling signal has a preselectable value.

The monitoring unit (R_1B) detects systematic (common mode) faults. One example of such a fault is a fault in the power supply. With the conventional brake system, the monitoring unit (R_1B) is configured as an independent microcomputer system. As an alternative, however, the monitoring unit (R_1B) may also be configured as a hardware module without its own processor, so that it is capable of executing concrete logic functions or, if it includes a register, it may even execute switching functions. An example of such a hardware module is, for example, an ASIC (applied specific integrated circuit), an FPGA (field-programmable gate array), or a monitoring circuit (watchdog).

In other systems, logic level L4 is always implemented in a separate component, which is also provided multiple times within the distributed safety-related system—e.g., in wheel modules of an electric brake system.

It is an object of the present invention is to facilitate the configuration of a distributed safety-related system while at the same time at least retaining the safety that is achievable on enabling the components.

To achieve this object, the present invention describes, starting with the method of the type defined in the preamble, that in addition to the first microcomputer system, the safety-related system should include at least one additional microcomputer system which is connected to the first microcomputer system for the purpose of data transfer, and at least one of steps b) through d) is executed in at least one of the additional microcomputer systems.

### SUMMARY OF THE INVENTION

It is thus described according to the present invention that a separate monitoring unit be omitted and that the functions of the monitoring unit instead be executed by such units of the distributed safety-related system that are provided in the system anyway. These units have their own intelligence to be able to perform their own calculations, at least to a limited extent. Such system units, which according to the present invention are capable of assuming the functions of the monitoring unit, include the microprocessors of one or more additional microcomputer systems.

A program code is processed on the microprocessor of the first microcomputer system to determine the triggering signal for the component as a function of the input signals. The program code is also processed on at least one of the additional microcomputer systems to determine the logic triggering signal for the component as a function of the same input signals. Processing of the program code on the additional microcomputer systems may occur, e.g., on the microprocessor or other suitable units (e.g., communications controller) which have adequate intelligence for processing the program code. The input signals are made available to the additional microcomputer systems, e.g., via a databus by which the microcomputer systems are interconnected for the purpose of data transfer.

The triggering signal determined by the first microcomputer system is compared with the logic triggering signals to ascertain whether or not the triggering signal is faulty. If all the microcomputer systems determine matching triggering signals, i.e., logic triggering signals, it may be assumed that the triggering signal is fault-free. It is self-evident that with an increase in the number of additional microcomputer systems, each of which determines logic triggering signals, the check on functionality of the first microcomputer system becomes more reliable. If a plurality of microcomputer systems monitor one another mutually, under some circumstances an identification, i.e., locating, of a defective microcomputer system is even possible.

According to an exemplary embodiment of the present invention, it is described that the safety-related system include, in addition to the first triggering module, at least one additional triggering module, and the at least one additional microcomputer system is part of the at least one additional triggering module. According to this exemplary embodiment, the distributed safety-related system thus includes a plurality of similar triggering modules in which the first microcomputer system and the additional microcomputer systems are arranged. This exemplary embodiment may provide that the triggering modules may have similar functions (e.g., activating and releasing a wheel brake as a function of existing input signals) and the program code for calculating the triggering signals in the microcomputer systems is largely the same. Thus, if the additional microcomputer systems of the additional triggering modules assume the functions of the monitoring unit, a separate program code need not be reserved in them and executed as necessary to determine the logic triggering signals. Instead, the program code present in the additional microcomputer systems anyway may be executed although using the input signals of the first microcomputer system. An example of a distributed system in which the method according to this exemplary embodiment may be implemented is an electric brake system which includes almost identical wheel modules for all wheels of a motor vehicle. In this exemplary embodiment, the redundancy often contained in distributed systems is thus utilized to reduce the complexity for reliable triggering of the components.

According to an exemplary embodiment of the present invention, it is described that step b) and step c) be executed in at least one of the additional microcomputer systems. According to this exemplary embodiment, thus the comparison between the triggering signal and the logic triggering signals is executed in the at least one additional microcomputer system. To do so, the triggering signal determined by the first microcomputer system is transmitted to the at least one additional microcomputer system, e.g., via a databus connecting the two together.

The first microcomputer system may be connected via a first communications controller to a physical bus system, whereby step b) is executed in at least one of the additional microcomputer systems, and step c) are executed in the first communications controller. Thus, according to this exemplary embodiment, the comparison between the triggering signal and the logic triggering signals is executed in the first communications controller via which the first microcomputer system is connected to the bus system. Communications controllers of more recent bus systems such as TTCAN (time triggered controller area network), TTP/C (time triggered protocol class C according to SAE) or FlexRay do not function as a “dumb” interface between the microcomputer system and the databus but instead they perform their own processing, sometimes highly complex, of the data to be transferred. They therefore have their own intelligence which is capable of executing operations such as comparisons or under some circumstances even more complex calculations. To be able to implement the comparison in the first communications controller, the at least one logic triggering signal is sent from the at least one additional microcomputer system to the communications controller, e.g., via a databus connecting the two together.

According to another exemplary embodiment of the present invention it is described that step d) be executed in at least one of the additional microcomputer systems. Accordingly, at least one enabling signal is determined in the additional microcomputer systems as a function of the result of the comparison of the triggering signal and the logic triggering signal. To do so, the triggering signal determined in the first microcomputer system is sent to the additional microcomputer systems, e.g., via a databus. In the additional microcomputer systems, it is then compared with the logic triggering signals determined there. The enabling signal is again relayed to the first microcomputer system, e.g., via a databus. The at least one triggering signal or at least one signal which depends thereon is then relayed to the component to be triggered if the enabling signals determined in the additional microcomputer systems have preselectable values. Thus, for example, there may be a comparison of the enabling signals or a majority decision.

According to an alternative exemplary embodiment of the present invention, it is described that the first microcomputer system be connected via a first communications controller to a physical bus system, and step d) is executed in the first communications controller. This means that the logic triggering signals determined in the additional microcomputer systems is relayed to the first communications controller, e.g., via a databus. The implementation of the method according to the present invention in the form of a computer program capable of running on a microcomputer system of a triggering module for triggering a component in a distributed safety-related system is of particular importance. The computer program is capable of running on a microprocessor of the microcomputer system and is suitable for execution of the method according to the present invention. In this case, the present invention is thus implemented by a computer program, so that the computer program represents the present invention in the same manner as the method for whose execution the computer program is suitable.

According to an exemplary embodiment of the present invention, it is described that the computer program be stored on a memory element, e.g., on a flash memory. For processing of the computer program and for execution of the method according to the present invention, the computer program is transferred by command or as a whole from the memory element into the processor.

The computer program coordinates the data transfer between the various units of the distributed system such that the method according to the present invention may be implemented. Which data is transmitted to which units depends on the units in which steps b) through d) are executed. However, the computer program also ensures in the various system units that the triggering signals and the logic triggering signals are determined and/or compared with one another.

### BRIEF DESCRIPTION OF THE DRAWINGS

FIG. 1 shows a distributed safety-related system in a sectional view for implementation of a method according to the present invention in a first exemplary embodiment.

FIG. 2 shows a triggering module known from other systems as part of a distributed safety-related system.

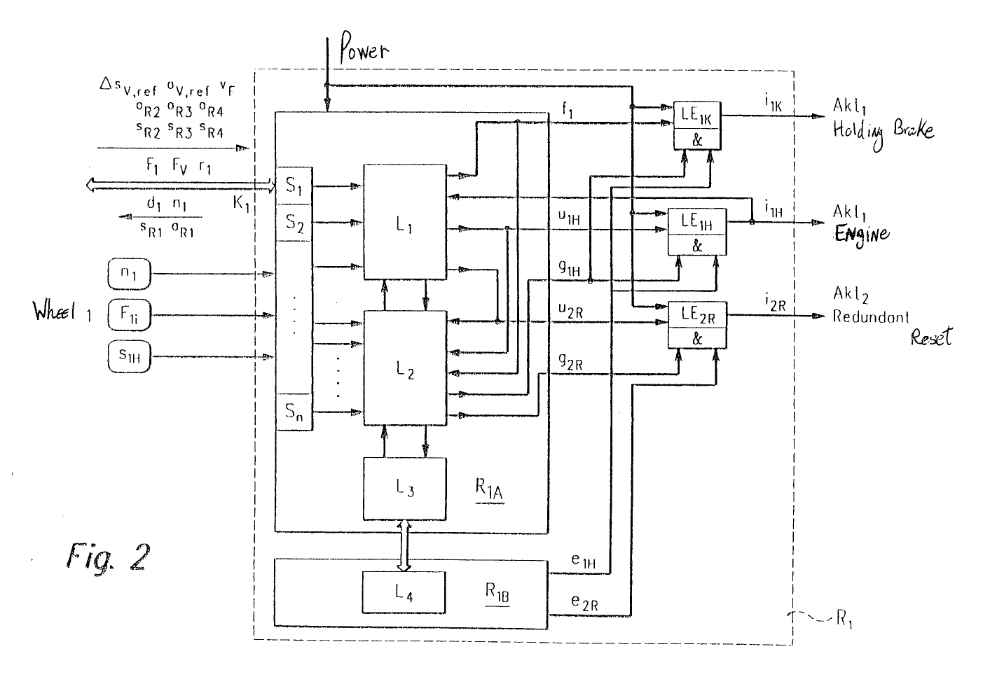

FIG. 3 shows a distributed safety-related system in a sectional view for implementation of a method according to the present invention in a second exemplary embodiment.

FIG. 4 shows a distributed safety-related system in a sectional view for implementation of a method according to the present invention in a third exemplary embodiment.

### DETAILED DESCRIPTION

The method according to the present invention is described below on the basis of an electric brake system. However, the present invention is not limited to electric brake systems, but instead may be used for any distributed safety-related systems. The present invention may allow reliable enabling of components in the safety-related system without the use of additional monitoring units. The functions of the monitoring units are instead assumed by units of the safety-related system which are present in the system anyway.

For each vehicle wheel to be braked, the brake system includes a wheel module R_1, R_m. Each wheel module R_1, R_m includes a microcomputer system P_1, P_m and an enabling circuit FS_1, FS_m. Microcomputer systems P_1, P_m each include a microprocessor Pro_1, Pro_m and an intelligent communications controller S_1, S_m. Microprocessor Pro_1, Pro_m and communications controller S_1, S_m of a microcomputer system P_1, P_m may be combined on a semiconductor module (called a chip); however, they are always configured as separate and independent units. Each wheel module R_1, R_m is connected to a physical databus K_1 via a communications controller S_1, S_m. Data is transmitted over the databus according to, for example, the TTCAN, TTP/C, or FlexRay protocol. Wheel modules R_1, R_m each control one actuator Akt_1, Akt_m which are configured as electric motors, for example, for actuation or release of the wheel brakes.

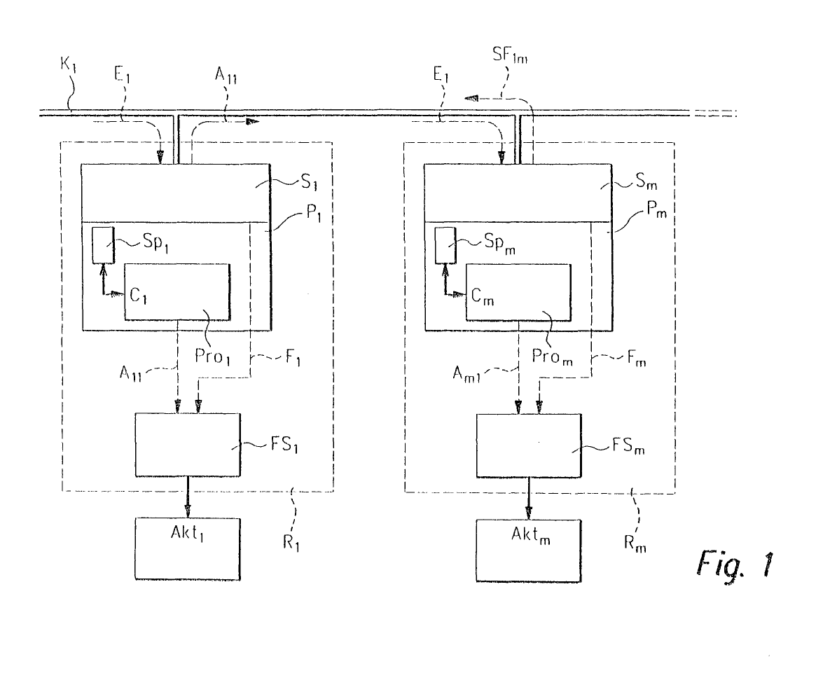

FIG. 1 shows the internal structure of two wheel modules and the signal flow of a method according to the present invention occurring therein according to a first exemplary embodiment. This method is used to trigger actuator Akt_1 of the electric brake system by wheel module R_1, i.e., by microcomputer system P_1. In triggering actuator Akt_1, it is important to prevent actuator Akt_1 from being triggered by a faulty triggering signal of microcomputer system P_1. This means that the triggering signal should be relayed to actuator Akt_1 only when it is certain with a sufficiently high probability that the signal is fault-free. Triggering of actuator Akt_1 therefore includes the following steps:

a) Processor Pro_1 of microcomputer system P_1 determines at least one triggering signal A_11 for actuator Akt_1 by processing a program code C_1 as a function of at least one input signal E_1. Input signals E_1 contain information regarding the actual status of the brake system and the motor vehicle and are relayed via databus K_1 to first wheel module R_1.

b) Processors Pro_m (e.g., m=2 . . . 4) of additional microcomputer systems P_m determine a logic triggering signal A_1m by processing program code C_1 as a function of input signals E_1. This presupposes that in addition to a program code C_m for determining triggering signals A_ml for actuators Akt_m, program code C_1 is available in processors Pro_m. In the present example including a plurality of similar wheel modules R_1, R_m, this means little or no additional complexity because program codes C_1, C_m running on processors Pro_1, Pro_m are the same.

Thus, program code C_m, which is available anyway in processors Pro_m, may be processed together with input signals E_1 to obtain logic triggering signals A_1m. This applies to all distributed systems including similar triggering modules. Input signals E_1 may be relayed to microcomputer systems P_m via databus K_1. With correct functioning of microprocessors Pro_1, Pro_m, triggering signals A_11 and logic triggering signals A_1m are identical.

c) In microprocessors Pro_m, triggering signal A_11 is compared with logic triggering signals A_1m determined there previously. To do so, triggering signal A_11 is relayed via databus K_1 to microcomputer systems P_m. Microprocessors Pro_m generate status information SF_1m which is in turn transmitted again via databus K_1 to first microcomputer system P_1. The status information includes for example one or more bits. It is conceivable for status information SF_1m to be tied into the protocol of the databus for transmission to first microcomputer system P_1.

d) Communications controller S_1 of first microcomputer system P_1 analyzes incoming status information SF_1m and, in the event of a corresponding status (i.e., when signaling a correct functioning of microprocessor Pro_1), it generates an enabling signal F_1. The analysis of status information SF_1m may occur in various manners. For example, it may be a comparison, a logic link (e.g., an AND link), or a majority decision of status information SF_1m.

e) Finally, the at least one triggering signal A_11 or at least one signal which depends thereon is relayed to actuator Akt_1 if the at least one enabling signal F_1 has a preselectable value. To check this, an AND link of triggering signal A_11 is executed in enabling circuit FS_1. If enabling signal F_1 is logic “1,” triggering signal A_11 is relayed to actuator Akt_1. However, if enabling signal F_1 is logic “0,” triggering signal A_11 is not relayed to actuator Akt_1.

The functioning of processor Pro_1 of microcomputer system P_1 may be checked by the method according to the present invention as described here and a reliable enabling of actuator Akt_1 may be achieved. To check on processor Pro_1, processors Pro_m of additional microcomputer systems P_m are mainly used. In the same manner, however, the method according to the present invention may also be used to check on the functionality of processors Pro_m of additional microcomputer systems P_1 and for reliable enabling of actuators Akt_m. Then additional processors Pro_m (not including the processor to be checked) and the processor Pro_1 of first microcomputer system P_1 are used for checking. Each individual microcomputer system within the safety-related distributed brake system thus in turn has the primary function of determining triggering signals A_11, A_ml for actuator Akt_1, Akt_m assigned to it and in turn checking on the secondary function, the function of the additional processors in fulfilling their primary functions. Without the use of additional monitoring units, the present invention thus creates the possibility of reliable and thus redundantly effective enabling of actuators Akt_1, Akt_m.

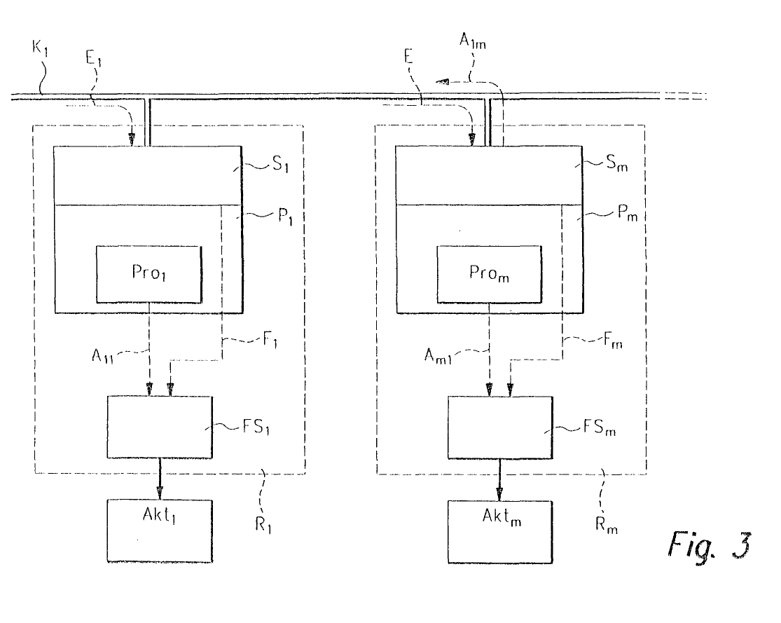

FIG. 3 shows the internal structure of two wheel modules and the signal flow of a method according to the present invention occurring therein according to a second exemplary embodiment. This method differs from the method illustrated in FIG. 1 in that step c) is executed in communications controller S_1 of first microcomputer system P_1.

Logic triggering signals A_1m determined in step b) in processors Pro_m of additional microcomputer systems P_m are relayed via databus K_1 to first microcomputer system P_1 where logic triggering signals A_1m are then compared with the at least one triggering signal A_11 in communications controller S_1 of first microcomputer system P_1 (step c)). Depending on the result of the comparison, status information SI_1m is determined in communications controller S_1 and then used to determine enabling signal F_1, or enabling signal F_1 is determined directly (step d)).

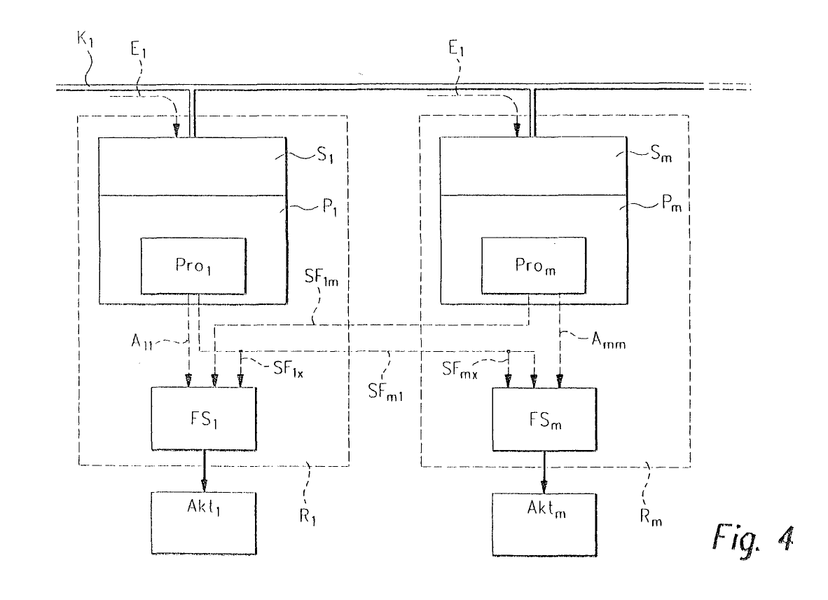

FIG. 4 shows the internal structure of two wheel modules and the signal flow of a method according to the present invention occurring therein according to a third exemplary embodiment. This method differs from the method illustrated in FIGS. 1 and 3, in that step d) is executed in enabling circuit FS_1 of first wheel module R_1.

As step c), a comparison between triggering signal A_11 and logic triggering signals A_1m determined there previously is executed in microprocessors Pro_m of additional microcomputer systems R_m. Microprocessors Pro_m generate status information SF_1m which is relayed via databus K_1 to first microcomputer system P_1 and from there to enabling circuit FS_1. This analyzes status information SF_1m, SF_1x arriving from all additional microcomputer systems P_m and relays the at least one triggering signal A_11 or at least one signal which depends thereon to actuator Akt_1 if status information SF_1m, SF_lx has a corresponding status. As an alternative, depending on the result of the comparison, status information SF_1m may first be determined in enabling circuit FS_1 and then used to determine enabling signal F_1. For analyzing status information SF_1m, SF_1x in enabling circuit FS_1 a voting mechanism is used. In the case of only two triggering signals A_11, A_12, the voting mechanism is an AND link of two signals A_11 and SF_1m. In the case of multiple triggering signals A_11, A_1m, the voting mechanism may be a majority decision.

(b) determining at least one logic triggering signal at least partially by a monitoring arrangement that is independent of the first microcomputer system, as a function of the at least one input signal;

(c) comparing the at least one triggering signal with the at least one logic triggering signal;

(d) determining at least one enabling signal as a function of a result of the comparison in step (c); and

(e) relaying one of the at least one triggering signal and at least one signal that depends on the at least one triggering signal to the component when the at least one enabling signal has a selected value;

wherein the distributed safety-related system includes at least one additional microcomputer system that is connected to the first microcomputer system for data transfer, and wherein at least one of steps (b) through (d) is executed by the at least one additional microcomputer system:

10. The method of claim 9, wherein the component is a component of an X-by-wire system in a motor vehicle.

11. The method of claim 9, wherein the safety-related system includes at least one additional triggering module, and wherein the at least one additional microcomputer system is part of the at least one additional triggering module.

12. The method of claim 9, wherein step b) and step c) are executed by the at least one additional microcomputer system.

13. The method of claim 9, wherein the first microcomputer system is connected via a first communications controller to a physical bus system, step (b) is executed by the at least one additional microcomputer system, and step (c) is executed by the first communications controller.

14. The method of claim 9, wherein step (d) is executed by the at least one additional microcomputer system.

15. The method of claim 9, wherein the first microcomputer system is connected via a first communications controller to a physical bus system, and wherein step (d) is executed by the first communications controller.

16. A computer-readable memory medium for storing a program to be executed by a computer, the program comprising a plurality of codes for controlling triggering of a component in a distributed safety-related system, the component being triggered by a first triggering module assigned to the component, by performing:
(a) determining at least one triggering signal for the component by the first microcomputer system as a function of at least one input signal;
(b) determining at least one logic triggering signal at least partially by a monitoring arrangement that is independent of the first microcomputer system, as a function of the at least one input signal;
(c) comparing the at least one triggering signal with the at least one logic triggering signal;
(d) determining at least one enabling signal as a function of a result of the comparison in step (c); and
(e) relaying one of the at least one triggering signal and at least one signal that depends on the at least one triggering signal to the component when the at least one enabling signal has a selected value;
wherein the distributed safety-related system includes at least one additional microcomputer system that is connected to the first microcomputer system for data transfer, and wherein at least one of steps (b) through (d) is executed by the at least one additional microcomputer system.

17. The computer-readable memory medium of claim 16, wherein the memory includes a flash memory.
